(19) United States
(12) Patent Application Publication
(10) Pub. No.: US 2025/0208593 A1
(43) Pub. Date: Jun. 26, 2025

(54) UNIVERSAL CONSOLE FOR STAGE AUTOMATION SYSTEM

(71) Applicant: TAIT TOWERS MANUFACTURING, LLC, Lititz, PA (US)

(72) Inventor: James D. LOVE, Lititz, PA (US)

(21) Appl. No.: 18/391,827

(22) Filed: Dec. 21, 2023

(51) Int. Cl. G05B 15/02

(52) U.S. Cl. CPC G05B 15/02

(57) ABSTRACT

A universal remote control console for managing operation of a plurality of theatrical objects that includes a plurality of remote user interfaces configured to mimic local user interfaces at the plurality of theatrical objects. The remove control console includes a remote controller with a remote interface communicatively coupled with interfaces for local controllers at the respective theatrical objects. By mimicking controls on the remote control console, theatrical object users are presented with familiar interfaces at the remote console location.

### FIELD OF THE INVENTION

The present disclosure is generally directed to control of theatrical objects on a stage and, more particularly, to a universal controller for integrating control of a plurality of discreet theatrical objects in a single control console.

### BACKGROUND OF THE INVENTION

The modern music and entertainment industry employs highly complex staging and set design in order to deliver engaging and entertaining shows, concerts or other productions. The staging may include numerous discrete aspects of the stage production operating in a concert as part of the overall production plan. These discrete aspects may include machinery for moving artists or equipment on the stage, lighting, sound, video projection, special effects, pyrotechnics, and even fog machines. Delivering each aspect in a coordinated manner as part of the production chorography requires precise control capability for each aspect.

At one time the state of the art in theatrical object movement and control systems included systems operating under the control of a central computer or microprocessor. Controllers capable of interfacing with the central computer were provided for individual theatrical objects to allow remote operation and automation of the objects. Advancements in the state of the art include decentralized or distributed control approaches in which microprocessors and memory devices are incorporated into the respective local control interfaces and a distributed control network architecture adopted allowing the local control interfaces to share in the automated control system processing load. Despite these advances in automation, providing full-node capablility at every theatrical object control interface may be neither efficient nor economical. This can lead to circumstances in which some theatrical objects are not controllable from a master automated control system unless an additional control interface is provided to bridge the control gap or controlling the theatrical objects individually, separate from the automated means.

What is needed is a universal user control console capable of interfacing with and controlling numerous discrete theatrical objects and providing a consistent operations interface for a user/operator and integration capability with known automated control systems. Additional benefits would be realized by a universal control console having sufficient computer processing capability for nodal function in a distributed control system architecture.

### SUMMARY OF THE INVENTION

Accordingly, the present invention, in any of the embodiments described herein, may provide one or more of the following advantages:

In one embodiment, a universal control console for managing operation of a plurality of theatrical objects includes a remote control system, a remote human interface having control actuators, indicators, and displays adaptable for remotely controlling the plurality of theatrical objects. The plurality of theatrical objects each include a local control interface connected to the universal controller wherein the control system is configurable to operably connect the control actuators, indicators, and displays on the universal controller to the plurality of theatrical objects and enable operation and control of the plurality of theatrical objects by a user from the human interface console through the control interfaces.

In another embodiment, a universal control console is provided for managing operation of a plurality theatrical objects from a single user interface location. A plurality of theatrical objects is provided, each theatrical object having a local controller and configured to manage the respective theatrical object. The universal controller is operably connected to each of the plurality of local controllers in a manner enabling control and operation of the theatrical objects from the universal control console.

In another embodiment, a universal control console for managing operation of a plurality of theatrical objects includes remote user interfaces mimicking respective local user interfaces provided for the plurality of theatrical objects. The universal control console includes a remote control system and a remote interface. The plurality of theatrical objects each include a local controller and a local control interface connected. The remote control system operably communicates with the local controller across the control interfaces enabling respective theatrical objects to be controlled from user interfaces at the universal control console.

In another embodiment, a universal control console includes an emergency stop actuator operably coupled to a remote control system. The remote control system includes a remote control interface communicatively coupled to local control interfaces for a plurality of theatrical objects and configured to allow actuation of the emergency stop actuator to stop operation of the plurality of theatrical objects by placing them in a safe operational configuration.

Other features and advantages of the present invention will be apparent from the following more detailed description of the preferred embodiment, taken in conjunction with the accompanying drawings which illustrate, by way of example, the principles of the invention.

### BRIEF DESCRIPTION OF DRAWINGS

The advantages of this invention will be apparent upon consideration of the following detailed disclosure of the invention, especially when taken in conjunction with the accompanying drawings wherein:

FIG. 1 schematically shows an embodiment of an automation and motion control system;

FIG. 2 schematically shows an alternate embodiment of an automation and motion control system;

FIG. 3 is a schematic representation of a universal controller system embodying aspects of the present invention; and

FIG. 4 is a diagrammatic view of a universal controller illustrating the relationship of the controller, local control interfaces, and theatrical objects;

Wherever possible, the same reference numbers will be used throughout the drawings to represent the same parts.

### DETAILED DESCRIPTION OF THE INVENTION

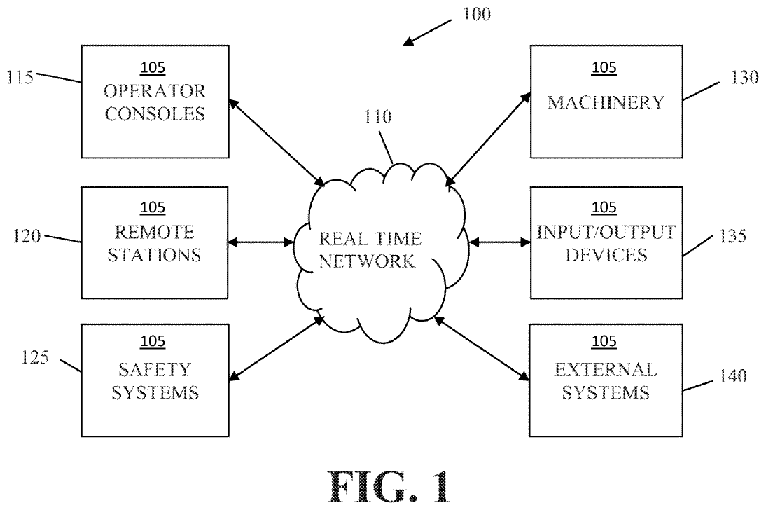

An exemplary automation and control system 100 shown in FIG. 1 can include a real time network 110 interconnecting devices 105 including operator consoles 115, remote stations 120, safety systems 125, machinery 130, input/output devices 135 and external systems 140. In one exemplary embodiment, safety systems 125 can include emergency stop (e-stop) systems; machinery 130 can include lifts, chain hoists, winches, elevators, carousels, turntables, hydraulic systems, pneumatic systems, multi-axis systems, linear motion systems (e.g., deck tracks and line sets), audio devices, lighting devices, and/or video devices; input/output devices 135 can include incremental encoders, absolute encoders, variable voltage feedback devices, resistance feedback devices, tachometers and/or load cells; and external systems 140 can include show control systems, industrial protocols and third party software interfaces including 0-10 V (volt) systems, Modbus systems, Profibus systems, ArtNet systems, BMS (Building Management System) systems, EtherCat systems, ethernet systems, DMX systems, SMPTE (Society of Motion Picture and Television Engineers) systems, VITC systems, MIDI (Musical Instrument Digital Interface) systems, sACN (streaming Architecture for Control Networks) systems, K-Bus systems, Serial systems (including RS 485 and RS 232), Ethernet systems, TCP/IP (Transmission Control Protocol/Internet Protocol) systems, UDP (User Datagram Protocol) systems, ControlNet systems, DeviceNet systems, RS 232 systems, RS 45 systems, CAN bus (Controller Area Network bus) systems, Maya systems, Lightwave systems, Catalyst systems, 3ds Max or 3D Studio Max systems, and/or a custom designed system.

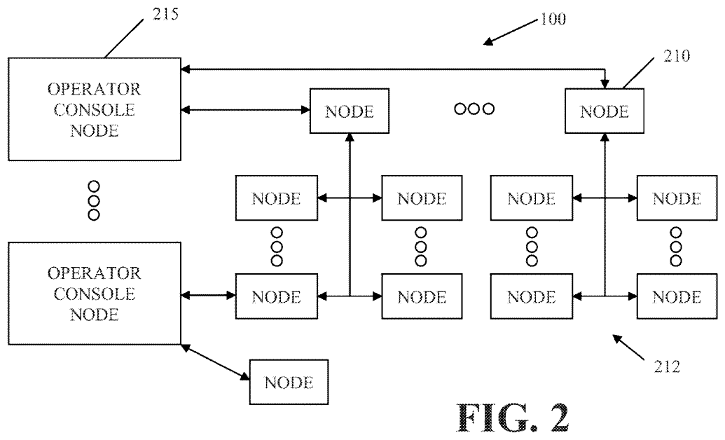

FIG. 2 shows an alternate embodiment of the automation and motion control system. The automation and motion control system 100 shown in FIG. 2 can be formed from the interconnection of logical nodes 210. Each node 210 can be a specific device (or group of devices) from remote stations 120, safety systems 125, machinery 130, input/output devices 135 and external systems 140. An operator console node 215 can be a specific device from operator consoles 115 and can enable an operator to interact with the control system 100, i.e., to send data and instructions to the control system 100 and to receive data and information from the control system 100. The operator console node 215 is similar to the other nodes 210 except that the operator console node 215 can include a graphical user interface (GUI) or human-machine interface (HMI) to enable the operator to interact with the control system 100.

In one exemplary embodiment, the operator(s) can make inputs into the system at operator console nodes 215 using one or more input devices, e.g., a pointing device such as a mouse, a keyboard, a panel of buttons, or other similar devices. As shown in FIG. 2, nodes 210 and operator console nodes 215 are interconnected with each other. Thus, any node 210, 215 can communicate, i.e., send and receive data and/or instructions, with any other node 210, 215 in the control system 100. In one exemplary embodiment, a group of nodes 210 can be arranged or configured into a network 212 that interconnects the nodes 210 in the group and provides a reduced number of connections with the other nodes 210, 215. In another exemplary embodiment, nodes 210, 215 and/or node networks 212 can be interconnected in a star, daisy chain, ring, mesh, daisy chain loop, token ring, or token star arrangement or in combinations of those arrangements. In a further exemplary embodiment, the control system 100 can be formed from more or less nodes 210, 215 and/or node networks 212 than those shown in FIG. 2.

In one exemplary embodiment the operator(s) can make inputs to the operator console nodes 215 using one or more input devices having user interfaces that are specifically designed for the types of theatrical objects that are being controlled. The input devices may include faders, display screens, buttons, switches, joysticks, and an emergency stop button. Theatrical objects may include machinery, lights, sound, projection, video screens, special effects, pyrotechnics, fog, and the like. The theatrical objects may be controlled by dedicated control consoles including lighting, sound, pyrotechnic or effects control consoles. These dedicated consoles may include remote stations 120, or consoles connected to safety systems 125, machinery 130, other input/output devices 135, or external systems 140 as illustrated in FIG. 1.

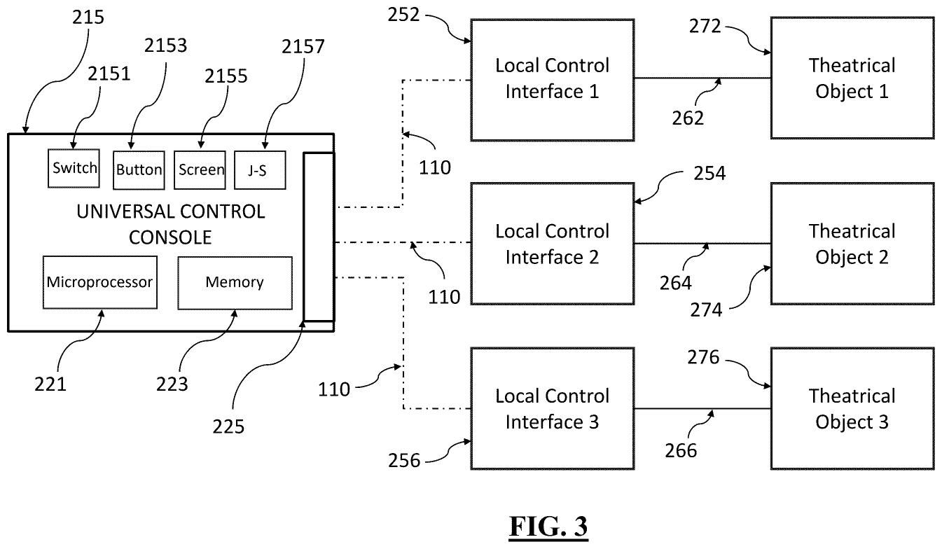

Referring to FIG. 3, a universal operator console 215 for remotely managing operation of a plurality of theatrical objects 272, 274, 276 is schematically shown. The theatrical objects include local control interfaces 252, 254, 256 that provide networking and hardware interfacing so that the universal console 215 may communicate with and manage operation of the plurality theatrical objects. The universal console includes a microprocessor 221, a memory device 223, and a remote control interface 225 enabling control communications between the microprocessor and the local control interfaces. The microprocessor and memory device are preferably physically disposed with the operator console 215, but may be operably coupled through the network or other control communication interface. The memory device 223 can include or store a process that can include one or more sub-or co-processes that are executable by the microprocessor 221. The process provides the networking and hardware interfacing to enable the sub-or co-processes to operate. The universal console 215 may include one or more human interface devices including switches 2151, buttons 2153, screens (touch and/or display) 2155, and joysticks 2157 proving remote user interfaces at the universal console.

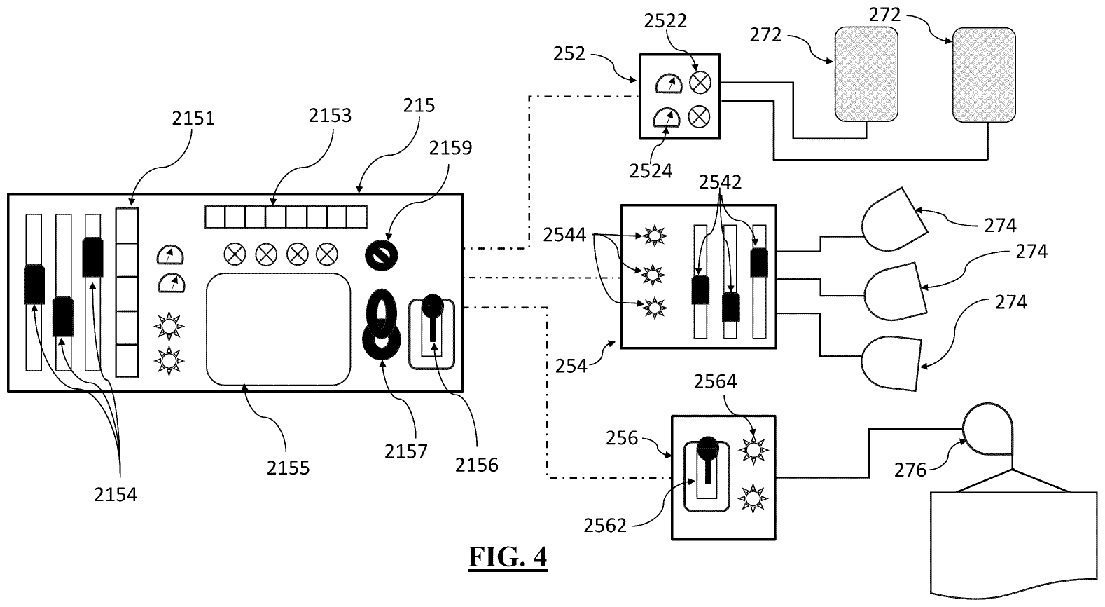

FIG. 4 provides an exemplar automation and control system including a remote universal control console 215 configured to interface with one or more local controllers thereby allowing a plurality of theatrical objects to be controlled from a single location. The universal control console may be operably coupled with the local control interfaces by the real-time network or by dedicated control connections using wired or wireless connections. The local control interfaces may include analog and/or digital control elements operably coupled to the theatrical objects.

The local controllers 252, 254, 256 may have human user interfaces permitting local operation of the respective theatrical object. Minimally, the local controllers include an interface configured to translate control of the respective theatrical object into a digital control interface compatible with the remote control interface of the universal console. The theatrical objects may include a sound system having a local sound controller 252 and speakers 272. The local sound controller may include volume level controls 2522 and volume level indicators 2524. The theatrical objects may also include a lighting system having a local lighting controller 254 managing operation of one or more lights 274. The local lighting controller may include dimmers controls 2542 and lighting status indicators 2544. The theatrical objects may also include a mechanical system such as a moveable backdrop moved by a winch 276, the movement thereof managed by a local winch controller 256. The local winch controller may include a position control 2562 and position or movement indicators 2564.

The universal console 215 may include one or more human interface devices including switches 2151, buttons 2153, screens (touch and/or display) 2155, faders, and joysticks 2157 configured to allow control of a plurality of theatrical objects from a single location using human interface devices that are similar to (mimic) those provided for local control of the theatrical devices. In the illustrated exemplar, the universal console includes remote volume level controls 2152, remote dimmers controls 2152, and a remote winch position control 2156 which mimic the user interface local control interfaces. The universal console may also include an emergency stop button 2159 or actuator that enables all theatrical objects to be placed in a safe operational condition in the event of an emergency.

Inherent in the universal control console is a method of consolidating control of a plurality of theatrical objects that may be physically dispersed about a stage by providing user interfaces at the remotely located universal control console that mimic user interfaces provided locally for each of the theatrical objects and connecting the remote user interfaces with the local user interfaces across a controlling network.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

It is important to note that the construction and arrangement of the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

1. A universal control console for remotely managing operation of a plurality of theatrical objects, the universal control console comprising:
a theatrical object operably coupled to a local controller, the local controller having a local user interface and a local control interface;
a remote control system having a remote control interface and a remote user interface, the remote user interface being disposed on the universal control console;
communication between the remote control interface and the local control interface operably coupling the remote control system to the local control system and enabling control of the theatrical object by the remote user interface.

2. The universal control console of claim 1, wherein the remote user interface comprises at least one of a display screen, a push button, a slider, and a rotary knob.

3. The universal control console of claim 1, wherein the plurality of theatrical object comprises at least one of a stage machine, a lighting component, an audio component, a pyrotechnic component, and a video component.

4. The universal control console of claim 1, wherein the remote user interface mimics the local user interface.

5. The universal console of claim 1, wherein the remote user interface includes an emergency stop interface configured to stop operation of the plurality of theatrical objects.

6. A method for remotely managing operation of a theatrical object comprising the steps of:
providing a remote console having a remote control interface and a remote user interface;
providing a theatrical object operably coupled to a local controller having a local control interface with a local user interface;
providing a communication link between the remote control interface and the local control interface configured to operably couple the remote console interface and the local controller; and
remotely controlling the theatrical object from the remote user interface.

7. The method of claim 6, wherein the remote user interface comprises at least one of a display screen, a push button, a slider, and a rotary knob.

8. The method of claim 7, wherein the remote user interface mimics the local user interface.

9. The method of claim 6, wherein the theatrical object comprises at least one of a stage machine, a lighting component, an audio component, a pyrotechnic component, and a video component.

10. The method of claim 6, wherein the remote user interface includes an emergency stop interface configured to stop operation of the theatrical object.
